(19) United States
(12) Patent Application Publication
(10) Pub. No.: US 2014/0353218 A1
(43) Pub. Date: Dec. 4, 2014

(54) SEPARATION OF LUMINESCENT NANOMATERIALS

(71) Applicant: Kaivogen Oy, Turku (FI)

(72) Inventor: Tero Soukka, Turku (FI)

(73) Assignee: KAIVOGEN OY, Turku (FI)

(21) Appl. No.: 14/372,399

(22) PCT Filed: Jan. 29, 2013
(86) PCT No.: PCT/FI2013/050092

§ 371 Date: Jul. 15, 2014

Related U.S. Application Data
(60) Provisional application No. 61/592,137, filed on Jan. 30, 2012.

(30) Foreign Application Priority Data
Jan. 30, 2012 (FI) 20125092

(51) Int. Cl. B03C 1/28; B03C 1/032

(52) U.S. Cl. CPC B03C 1/28; B03C 1/032
USPC 209/214

(57) ABSTRACT

The invention relates to analysis of photon upconversion luminescent inorganic lanthanide-doped nanomaterials and/or separation and/or purification of them from other materials such as biomolecules and/or chemicals used e.g. for bioconjugation in preparation of reagents based on upconverting lanthanide nanoparticles for bioanalytical assays. The invention utilizes a high gradient magnetic separator (HGMS) and it can be applied from large submicron materials to small nanoparticles just nanometers or tens of nanometers in diameter. It is also scalable from small analytical scale to preparative scale.

### FIELD OF THE INVENTION

The present invention relates to analysis of small, colloidally stable, inorganic lanthanide-doped upconversion luminescent nanomaterials and/or separation and/or purification of them from other (nonmagnetic) materials such as organic molecules and/or biomolecules utilizing a high gradient magnetic separation (HGMS) system and the lanthanide dopant ions. The invention thus enables a new kind of magnetic chromatography for separation and/or purification and/or fractionation and/or analysis of lanthanide doped nanomaterials, especially photon upconversion luminescent nanomaterials based on their intrinsic feature, i.e. presence of doped lanthanide ions responsible for the luminescence property.

### BACKGROUND OF THE INVENTION

The publications and other materials used herein to illuminate the background of the invention, and in particular, cases to provide additional details respecting the practice, are incorporated by reference.

Upconversion luminescence, also so called anti-Stokes photoluminescence, is a unique phenomenon in which lower energy, typically infrared (IR) excitation light is converted to higher energy visible emission light. This is possible due to sequential absorption of two or more infrared photons of same or different energy in two or more stages, generating a single higher energy photon (shorter wavelength). There are many different upconversion processes, most efficient of which are excited-state absorption (ESA) and energy-transfer upconversion (ETU, also called APTE for addition de photon par transfers d'energie). (Auzel, F. E.: Up-conversion in rare-earth-doped systems: past, present and future. Proc. SPIE 2002; 4766: 179-190.)

Only certain materials possess the capability of efficient photon upconversion, i.e. anti-Stokes photoluminescence by sequential absorption of multiple photons. They are inorganic crystals and nanocrystals which contain trivalent lanthanide ions as dopants. Lanthanides comprise fifteen chemical elements with atomic numbers 57-71. Together with scandium and yttrium these elements are called rare earth elements. They have similar chemical properties due to shielded 4f-orbital. All the trivalent lanthanides also have unpaired f-electrons i.e. they are paramagnetic. However, their magnetic moments vary, e.g. erbium (Er³⁺) has a magnetic moment of 9.5 Bohr magnetons and holmium (Ho³⁺) 10.3 Bohr magnetons (Evans, C. H. and Tew, W. P.: Isolation of biological materials by use of Erbium(III)-induced magnetic susceptibilities. Science 1981; 213: 653-654). The most typical lanthanides used as dopants in photon upconverting materials are ytterbium (Yb³⁺), erbium (Er³⁺), thulium (Tm³⁺) and holmium (Ho³⁺), but also e.g. praseodymium (Pr³⁺), neodymium (Nd³⁺), cerium (Ce³⁺), europium (Eu³⁺), samarium (Sm³⁺) and terbium (Tb³⁺) have been used. (Haase, M. and Schäfer, H.: Upconverting nanoparticles. Review. Angew. Chem. Int. Ed. 2011; 50: 5808-5829.) Most of these lanthanides can act as activators (activator ions) in an upconverting material i.e. they can emit a photon; the most common activators are Er³⁺, Tm³⁺ and Ho³⁺. The upconversion can be enhanced by adding a sensitizer ion, most commonly ytterbium (Yb³⁺), which absorbs the excitation energy and transfers it resonantly to the activator. The dopants provide luminescent centers when their concentration in the particle is small enough (from less than one mol-% to few tens of mol-%) to prevent concentration quenching, but yet at least a minimum concentration is required to enable adequate adsorption by sensitizer and energy-transfer between dope-ions, i.e. from sensitizer to activator ions.

The luminescence of upconverting materials depends not only on the dopant ions and their concentration and ratio, but also on the host material, i.e. the host lattice itself. The host lattice determines the distance and spatial position between the dopant ions. The host material should have low phonon energies to prevent nonradiative energy loss and to maximize the radiative emission, and the inorganic ions should have about the same ionic size as lanthanides. Oxides exhibit high phonon energies, while chlorides, bromides, fluorides and iodides have low phonon energies. Fluorides are the most used host materials because they also are chemically the most stable. Cations like Na⁺, K⁺, Ca²⁺, Y³⁺, Sr²⁺Ba²⁺, Zr⁴⁺ and Ti⁴⁺ have ionic radii close to lanthanides (Wang, F. and Liu, X.: Recent advances in the chemistry of lanthanide-doped upconversion nanocrystals. Review. Chem. Soc. Rev. 2009; 38: 976-989). The most efficient upconverting material to date is NaYF₄ doped with Yb³⁺ and Er³⁺. Also the crystal structure has an effect on luminescence efficiency: hexagonal crystal produces approximately 10 times stronger luminescence than cubic crystal. (Krämer, K. W., Biner, D., Frei, G., Güdel, H. U., Hehlen, M. P. and Lüthi, S. R.: Hexagonal sodium yttrium fluoride based green and blue emitting upconversion phosphors. Chem. Mater. 2004; 16: 1244-1251.) Upconverting nanomaterials, especially nanosized colloidal particles present an additional problem. Since the surface area increases, more activator ions are at or near the surface and thus there are more pathways for nonradiative energy loss (Stouwdam, J. W. and van Veggel, J. M.: Near-infrared emission of redispersible Er³⁺, Nd³⁺, and Ho³⁺ doped LaF₃ nanoparticles. Nano Letters 2002; 2: 733-737).

Nanosized inorganic upconverting particles can be synthesized by many methods. Sunstone Upconverting Nanocrystals with slightly rodlike shape and average diameter of 40 nm are also commercially available with either carboxylated surface or coated with avidin from Sigma Aldrich (St. Loius, Mo.). Wang et al. introduced a simple method where the colloidally stable nanosized NaYF₄: Yb³⁺, Er³⁺ particles were synthesized in organic oils. Lanthanide chlorides in methanol were mixed with oleic acid and 1-octadecene, and the solution was heated to 160° C. for 30 min and then cooled down to room temperature. Thereafter, methanol solution of NH₄F and NaOH was added and the mixture was stirred for 30 min. After the methanol evaporated, the solution was heated to 300° C. under argon for 1.5 h and cooled down to room temperature. The resulting nanoparticles were washed several times and re-dispersed in cyclohexane. (Wang, F., Han, Y., Lim, C. S., Lu, Y., Wang, J., Xu, J., Chen, H., Zhang, C., Hong, M. and Liu, X.: Simultaneous phase and size control of upconversion nanocrystals through lanthanide doping. Nature 2010; 463: 1061-1065.) Another method for the synthesis of ˜10-nm hexagonal NaYF₄: Yb³⁺, Er³⁺ particles was introduced by Yi and Chow in 2006. The method was based on thermal decomposition of trifuoroacetates of both sodium and the lanthanides. The mixture of trifluoroacetates was heated to 330° C. and kept there for an hour after which the heating was stopped. The mixture was cooled to 80° C. and ethanol was added and then washed several times. (Yi, G. S. and Chow, G. M.: Synthesis of hexagonal-phase NaYF₄:Yb,Er and NaYF₄:Yb,Tm nanocrystals with efficient up-conversion fluorescence. Adv. Fund. Mater. 2006; 16: 2324-2329.)

Surface modification of photon upconverting lanthanide-doped nanomaterials and their use in diagnostics and therapeutic applications has been described in WO 2011/063356.

There are a number of methods suitable for separation of biomolecules or chemicals from inorganic lanthanide-doped nanomaterials. These methods include ultracentrifugation with very high g-forces, gradient centrifugation, ultrafiltration or dialysis with nanoporous membrane, or size exclusion chromatography (gel filtration). The currently existing methods are time-consuming (e.g. centrifugation and dialysis), they result in low yield (e.g. centrifugation), dilute the sample (e.g. size exclusion chromatography) or it may be difficult to detach the nanomaterials from the membrane used for separation (e.g. ultrafiltration and dialysis). There is thus a need for improved, more rapid and preferably concentrating separation method for especially nanosized colloidally stable photon upconverting particles and their derivatives, e.g. particles coated with proteins or other biomolecules.

EP 0 941 766 and U.S. Pat. No. 6,020,210 of Miltenyi, disclose a high gradient magnetic separation (HGMS) column to the separation of biological materials. Macromolecules and/or cells are coupled to iron-based magnetic particles (designed for magnetic applications) which are trapped in the HGMS-column matrix in a magnetic field. U.S. Pat. No. 4,508,625 of Graham, discloses a process of capturing cells or other organic or inorganic particles with a negative surface charge in a HGMS-system by mixing them with chelated paramagnetic ions and inserting a magnetic field.

High gradient magnetic separators (HGMS) can be used in many magnetic separation applications including the capture of weakly paramagnetic materials. The separators comprise of a container filled with a magnetizable matrix, usually containing pads of stainless steel wool or stacked layers of wire mesh or superparamagnetic particles. When an external magnetic field is introduced to the container, a magnetic gradient is generated in the matrix and it starts to strongly attract paramagnetic and especially ferromagnetic particles. The efficiency of capture of magnetic particles in a system with wire mesh as a matrix can be described with the following equation:

$${v}_{r} = \frac{{v}_{m}}{{v}_{0}} = \frac{2 {μ}_{0} ( {χ}_{s} - {χ}_{f} ) {M}_{w} {H}_{0} {b}^{2}}{9 η {av}_{0}}$$

where vₘ is the magnetic velocity, v₀ the applied fluid velocity, μ₀ the permeability of free space, χₛ and χ_{f} are the magnetic susceptibility of the support and liquid, respectively, M_{w} is the magnetization of the wire, H₀ is the field strength of the applied magnetic field, η is the viscosity of the liquid, a is the radius of the wire, and b the particle radius. (Shukla, A. A., Etzel, M. R. and Gadam, S.: Chapter 3. Product recovery by high-gradient magnetic fishing (HGMF). In a book: Process scale bioseparations for the biopharmaceutical industry. 2007, CRC Press, Taylor & Francis Group, U.K.)

Separation of coated magnetic nanoparticles (about 8 nm in diameter) comprising magnetite core (i.e. FeO.Fe₂O₃) by HGMS has been described (Moeser, G. D., Roach, K. A., Green, W. H, and Haton T. A., High Gradient Magnetic Separation of Coated Magnetic Nanoparticles. AlChE Journal 2004; 50: 2835-2848). It describes the magnetic chromatography of polymer and phospholipid-coated magnetic nanoparticles using different magnetic fluid flow velocities and effect of the core size to the purification.

The upconverting material can be synthesized around a nanosized magnetic core, which can be for example gadolinium or magnetite, i.e. FeO.Fe₂O₃, (which is superparamagnetic below a diameter of 25 nm). Gadolinium has a relatively high magnetic moment (7.94 Bohr magnetons). This method produces a core-shell-particle with magnetic properties in the core part and upconversion capability in the shell part, respectively. (Wilhelm, S., Hirsch, T., Scheucher, E., Mayr, T. and Wolfbeis, O. S.: Magnetic nanosensor particles with luminescence upconversion capability. Angew. Chem. Int. Ed. Engl. 2011; 50: A59-62.) Synthesis of magnetic, upconversion luminescent core-shell-structured nanoparticles containing Fe₃O₄ magnetite core has been described also by others (Gai, S., Yang, P., Li, C., Wang, W., Dai, Y., Niu, N. Synthesis of Magnetic, Up-Conversion Luminescent, and Mesoporous Core-Shell-Structured Nanocomposites as Drug Carriers Adv. Funct. Mater. 2010; 20: 1166-1172). The entire particle volume is, however, not optically active and the luminescence of the nanomaterial is inevitably compromised. Another way to increase the magnetic properties of the upconverting particles is to add a paramagnetic molecule on the surface silica coating (Li, Z., Zhang, Y., Shuter, B. and Idris, N. M.: Hybrid lanthanide nanoparticles with paramagnetic shell coated on upconversion fluorescent nanocrystals. Langmuir 2009; 25: 12015-12018). This has also been suggested in WO 2011/063356, where magnetic particles are attached to the shell of the UCLnNPs.

### OBJECT AND SUMMARY OF THE INVENTION

The object of the present invention is to provide a method for capture of upconverting lanthanide-doped nanoparticles (UCLnNPs).

The present invention provides a method comprising capture of upconverting lanthanide-doped nanoparticles (UCLnNPs) of a sample comprising said UCLnNPs by a high gradient magnetic separator (HGMS) wherein the weak magnetic, preferably paramagnetic, properties of the lanthanides within the host material in said UCLnNPs enable capture by said HGMS.

Further aspects of the invention are described in the dependent claims.

### BRIEF DESCRIPTION OF THE DRAWINGS

FIG. 1 illustrates an example construction of the used HGMS-system.

FIG. 2 illustrates another example construction of the used HGMS-system.

FIG. 3 illustrates the use of one embodiment of the invention with a sample comprising photon upconverting lanthanide-doped nanoparticles and with three different magnetic fields.

FIG. 4 illustrates reference values without a magnetic field.

FIG. 5 illustrates reference values with non-magnetic particles.

FIG. 6 illustrates the use of one embodiment of the invention for separation of a sample comprising both photon upconverting lanthanide-doped nanoparticles and dyed latex particles.

### DETAILED DESCRIPTION OF THE INVENTION

This invention provides a discovery that the weak paramagnetic properties of the lanthanide ions doped, preferably uniformly and/or homogeneously distributed within the host material, in the inorganic rare earth-based photon upconverting lanthanide nanoparticles (UCLnNPs), thus providing optimal luminescence features are enough for a high gradient magnetic separator (HGMS) to capture and separate these upconverting lanthanide-doped nanoparticles (UCLnNPs). When a magnetic field is applied (e.g. placing a supermagnet or pair of such around the column) to the column packed e.g. with small paramagnetic microbeads (i.e. matrix) and a sample containing e.g. UCLnNPs mixed with biomolecules is applied to column, the experiment results in UCLnNPs staying/concentrating in the column and biomolecules (within eluation/washing buffer) eluting from the column. After the magnetic field is removed the UCLnNPs can be simply eluted from the column in the eluting liquid/buffer/solvent. This enables very simple and efficient, rapid separation of the UCLnNPs from different biomolecules and chemicals (nonmagnetic materials) without diluting the photon upconverting nanophosphors—or actually concentrating them in a convenient way—and also a convenient method for their buffer exchange.

Surprisingly capture of lanthanide-doped photon upconverting nanomaterials can be achieved magnetically without a magnetic core of the nanoparticles but by intrinsic magnetic susceptibility of the weakly but sufficiently paramagnetic lanthanide(III) ions, which also produce the photon upconversion luminescence, doped in the host material of the UCLnNPs. This demands the large force from magnetic gradient produced in HGMS-system when the HGMS-column is introduced into a homogeneous external magnetic field.

The inventors have discovered that by using HGMS a magnetically highly responsive core within the upconverting particle is no more necessary to enable magnetic separation of the upconverting material, and thus even UCLnNPs that have rare earth composition optimized for photon upconversion luminescence can be purified/separated/analyzed by utilizing the weak paramagnetic properties of their intrinsic lanthanide dopants responsible for photon upconversion luminescence. Thus, no magnetic particles in a shell within an upconverting particle are needed to enable magnetic separation of the upconverting material.

The invention is highly beneficial, since to obtain optimal photon upconversion luminescence the presence of elements resulting in quenching of the luminescence, such Fe, Co or Ni, within UCLnNPs should be avoided. The magnetic core or magnetic particles in a shell comprise typically one or multiple of these elements. Saleh et al. has described that heavy metal ions, including Fe^{III} and Co^{II}, quench the luminescence of upconverting nanomaterials (Saleh, S. M., Ali, R. and Wolfbeis, O. S. Quenching of the luminescence of upconverting luminescent nanoparticles by heavy metal ions. Chem. Eur. J. 2011; 17: 14611-14617).

In the UCLnNPs optimized for photon upconversion luminescence the entire host material (e.g. NaYF₄ or NaGdF₄) is preferably doped uniformly with lanthanide dopant ions, i.e. the distribution of lanthanide dopant ions within host material is close to homogeneous, and the host material does not contain any separate core with different composition optimized for magnetic separation. The UCLnNPs may further be coated on their surface by a magnetically (also paramagnetically) and optically inert layer such as silica shell enabling their derivatization.

Efficient photon upconversion luminescent nanomaterials such as UCLnNPs comprise always lanthanides doped within the host material. Photon upconversion is not possible without the optically active lanthanide dopants acting as luminescent centres within the host material. The inventors have discovered that these lanthanide dopants necessary for the photon upconversion and present in the host material enable also magnetic separation of the photon upconverting lanthanide-doped nanoparticles (UCLnNPs). Magnetic separation is based on the use of high gradient magnetic separation (HGMS) and magnetic properties, more specifically paramagnetism of the lanthanides doped within the host material of the UCLnNPs. Photon upconversion requires a minimum concentration of lanthanides present within the host material and this concentration is surprisingly adequate also for HGMS-based separation of the UCLnNPs.

One object of the present invention is to provide a method to purify and/or separate photon upconversion luminescent nanomaterials, such as upconverting lanthanide nanoparticles (UCLnNPs) from other non-magnetic or magnetically different materials and molecules such as monomers, polymers, biomolecules, or chemicals or to provide a method for aqueous buffer or liquid exchange of photon upconversion luminescent nanomaterials.

Another object of the present invention is to provide a method to purify and/or to separate and/or fractionate upconversion luminescent nanomaterials with different size or composition or shape from each other or to provide a method for analysis of upconversion luminescent nanomaterials comprised in the sample suspension.

A further object of the present invention is to provide a method for preparation of surface coated, surface modified, surface activated and biomolecule conjugated derivatives of upconversion luminescent nanomaterials such as silica coated UCLnNPs, carboxylated UCLnNPs and protein, oligonucleotide and hapten coated UCLnNPs enabling convenient and relatively rapid separation and/or purification and/or concentration and/or buffer exchange of UCLnNPs with high yields in a single step or multiple steps of the conjugation procedure requiring purification of derivatized UCLnNPs from liquids and suspensions containing other reagents such as silica monomers, silica polymers, biomolecules or biopolymers, also bioconjugation activation or quenching reagents or blocking reagents

The present invention provides a convenient and rapid separation and/purification technology for upconversion luminescent nanomaterials, that is scalable from small analytical scale to preparative scale.

The present invention also provides a method for analysis of upconversion luminescent nanomaterials.

The present invention further provides a purification and/or conjugation kit and procedure for separation and/or purification of inorganic lanthanide-dope photon upconversion luminescent nanomaterials.

The invention enables purification/separation and analysis of the inorganic upconverting lanthanide-doped nanoparticles optimized for their luminescent properties, which thus have preferably a uniform elemental content and homogeneous composition within the entire host material or a core-shell structure, where both core and shell are optically active. In case of core-shell particles, neither the core or shell of the particle are selected as optically inactive, such as in the prior art, e.g. core is not selected to contain solely magnetically highly responsive material (e.g. magnetite, ferrous or gadolinium rich). The invention also enables purification/separation and analysis of the derivatives of the upconverting lanthanide-doped nanoparticles based preferably on the paramagnetic properties of their lanthanide dopants within host material responsible for photon upconversion.

The luminescent lanthanide-doped nanocrystals optimized for luminescence contain yet a small percentage of paramagnetic lanthanide ions, e.g. Yb³⁺ and Er³⁺ doped within the host material, rendering them very weakly magnetically responsive. The magnetic susceptibility of the small particles is however too weak in practice for the use of conventional magnetic separation and has been inevitably discarded as a potential separation method. The luminescent lanthanide-doped nanoparticles optimized for luminescence are typically homogeneous nanoparticles that do not contain an optically inactive core, i.e. the host material does not comprise a separate optically inactive core or a core with different composition inside the optically active host material comprising the luminescent centres.

The invention enables a new kind of magnetic chromatography for separation or purification or analysis of lanthanide doped nanomaterials. It provides a simplified process and significant advantages to e.g. centrifugation, ultrafiltration, gel filtration/size exclusion chromatography, density gradient centrifugation etc. It can be used also to fractionate lanthanide-doped nanomaterials of different sizes or rare earth compositions, purifying them from other nanomaterials, e.g. silica-coated UCLnNPs, from biomolecules, proteins, nucleic acids and other molecules such as chemicals used for surface modification or activation during bioconjugation or preparation of labelled reagents for bioanalytical assays, and also “empty” silica particles which are not formed around UCLnNPs, i.e. do not contain optically active photon upconverting material. Especially separation of “empty” silica particles and silica-coated UCLnNPs with identical size is difficult with most of the existing methods due to their potentially identical diameter, shape and surface characteristics.

In HGMS the magnetic attraction force on the lanthanide-doped nanomaterials (nanoparticles) is dependent on the magnetizing gradient in the column. In the quite homogeneous magnetic external field applied to the column the gradient is preferably generated within the column by the magnetically susceptible packing. The generation of gradient is yet dependent on the homogeneous magnetic field and preferably a very strong magnetic field should be applied (from 1 mT to several T, preferably >0.01 T, more preferably >0.1 T and most preferably >0.5 T) although a weaker field may be preferred for fractionation or size selective capture. The packing (the matrix) generates the (variable) gradient by locally disturbing the homogeneous magnetic field and thus generating gradients within the entire matrix. The gradient density can be increased by using strongly magnetically susceptible packing (the matrix) and/or using smaller diameter wires/meshes/microbeads. The separation is dependent on the size of the nanomaterial and the lanthanide dopant (magnetically responsive) concentration and type(s) as the Brownian motion provides the competing force for the magnetic attraction force. The method is thus also suitable e.g. for separation of nanomaterials from nanomaterial aggregates. Lower temperature may thus be beneficial for more effective separation of the lanthanide-doped nanomaterials.

### DEFINITIONS

In this disclosure the term “magnet” shall be understood as a permanent magnet, permanent super magnet, electromagnet or a superconducting electromagnet that generates either a static or alternating magnetic field. The shape and size of the magnets can vary.

The term “supermagnet” shall be understood as to describe a permanent rare earth magnet (neodymium-iron-boron or samarium-cobalt magnet) which is multiple times stronger than a conventional permanent magnet. Neodymium magnets are the strongest type of permanent magnets made.

The term “magnetic field” shall be understood to cover a magnetic field with no limitations in strength or shape, formed with one or multiple magnets and/or combinations of the different types of magnets. Magnetic field can be constant or alternate from time to time. Preferably the strength of the magnetic field is at least 1 mT, more preferably more than 0.01 T, even more preferably higher than 0.1 T and most preferably higher than 0.5 T. The strength of the magnetic field can be controlled by altering the distance between the magnets and/or the distance from the column and/or altering the current of an electromagnet.

The term “magnetically susceptible” shall be understood as to describe a material which shows attraction to a magnet when placed in a magnetic field.

The terms “ferromagnetic” and “ferrimagnetic” shall be understood as to describe a material which can show magnetism after being placed in a magnetic field and after the magnetic field has been removed still shows magnetization (remanent magnetization), and is strongly attracted to a magnet when placed inside one's field. The difference between these two is that in ferromagnetic material the alignment of the magnetic ions is the same, when in ferrimagnetic material some of the ions can be anti-aligned.

The term “paramagnetic” shall be understood as to describe a material which shows magnetism when placed inside a magnetic field but permanent or remanent magnetization does not take place. Paramagnetic material does not retain any magnetization in the absence of an externally applied magnetic field. Paramagnetism is a form of magnetism where the paramagnetic material shows magnetism in the presence of an externally applied magnetic field.

The term “superparamagnetic” shall be understood as to describe a material which can randomly flip the direction of its magnetic field under the influence of temperature. It appears in small ferromagnetic or ferrimagnetic particles. When placed in an external magnetic field superparamagnetic material is magnetized, similarly to paramagnetic material.

The term “photon upconversion” shall be understood as the phenomenon of conversion of low-energy excitation light to high-energy light by absorbing the low-energy light and emitting the high-energy light, i.e. anti-Stokes photoluminescence. UCLnNPs are capable of photon upconversion by absorbing sequentially two or more typically infrared photons (with identical or different wavelength) to emit a single visible photon. Lanthanide-based photon upconversion is anti-Stokes photoluminescence produced by sequential absorption of multiple photons by lanthanide dopant ions within inorganic host lattice or by lanthanide chelate complex.

The term “nanoparticles” shall be understood as sub-micrometer size colloidal particles, in the size range of 1 nm to 1 μm, more preferably 1 nm to 500 nm, even more preferably 1 nm to 100 nm, and most preferably 1 nm to 50 nm.

The term “UCLnNPs” and “UCLnNP-(nano)crystals” shall be understood as inorganic upconverting lanthanide-doped nanoparticles comprising a crystal lattice of host material and lanthanide dopant ions. The UCLnNPs can have spherical, cubic, hexagonal or rodlike shapes and their dimensions can vary from 1 nm up to 1 micron. UCLnNPs for bioapplications do preferably have dimensions less than 500 nm, more preferably less than 100 nm. The crystal lattice can consist of halides, chlorides, bromides, iodides, oxides, sulphates, phosphates, vanadates, or fluorides and single or multiple type of optically inert cations such as Na⁺, K⁺, Ca²⁺, Sr²⁺, Ba²⁺, La³⁺, Y³⁺, Gd³⁺, Lu³⁺, Zr⁴⁺ or Ti⁴. Preferably the host material is a fluoride containing at least two kinds of cations selected from Na⁺, K⁺, Gd³⁺, and Y³⁺. The most efficient UCLnNPs are NaYF₄ doped with Yb³⁺ and Er³⁺, Tm³⁺, Nd³⁺, or Ho³⁺-ions or any combinations thereof.

The term “spherical particle” shall be understood as particles with any spherical-like three-dimensional shape including sphere, ellipsoid, cube, any polyhedron shape and any irregular three-dimensional shape with a smooth or a rough surface.

The term “dopant” shall be understood as trivalent lanthanide ion, doped inside an UCLnNP-nanocrystal in the host material providing luminescent centres. Lanthanides comprise fifteen chemical elements with atomic numbers 57-71. Dopant lanthanides (dope or dopant ions) are most preferably ytterbium (Yb³⁺), erbium (Er³⁺), thulium (Tm³⁺) and holmium (Ho³⁺), but can also be praseodymium (Pr³⁺), neodymium (Nd³⁺), cerium (Ce³⁺), europium (Eu³⁺) and terbium (Tb³⁺). The concentration of trivalent lanthanide dopant ions can be in the range of less than one mol-% to a few tens of mol-%. Dopants can act as sensitizers or activators, i.e. as luminescent centres.

The term “host material” shall be understood as host lattice, i.e. crystal lattice or mixture of crystal lattices of solid inorganic material. The host materials are typically oxides, nitrides and oxynitrides, sulfides, selenides, halides (e.g. NaYF₄) or silicates of zinc, cadmium, manganese, aluminium, silicon, or various rare earths. Some of the atoms of host material can be replaced by doped ions or dopants, such as lanthanides doped within host material. In rare earth-based host material the atoms can be replaced by lanthanides. Optically active dopants within host material are called activators and sensitizers. Preferably the crystal phase of the host material is hexagonal.

The term “luminescent center” shall be understood as any of the dopants involved in generation of upconversion luminescence within the UCLnNP-host material. The luminescent centers of UCLnNPs comprise emitting activator ions, preferably Er³⁺, Tm³⁺ or Ho³⁺, and optionally absorbing sensitizer ions, preferably Yb³⁺, which transfer their excited energy to the activator ions.

The term “lanthanide” shall be understood as any of the fifteen metallic chemical elements with atomic numbers 57-71 from lanthanum (La) to Lutetium (Lu). A chemical symbol Ln can be used when discussing generally about lanthanides. Lanthanides have rather similar chemical and magnetic properties.

The terms “rare earth” and “rare earth metal” shall be understood as any of the fifteen lanthanides plus scandium and yttrium. Scandium and yttrium are considered as rare earth elements since they tend to occur in the same deposits as the lanthanides and exhibit similar chemical properties.

The term “sample” shall be understood as a batch of synthesized UCLnNPs or a mixture of UCLnNPs or UCLnNPs coated with other molecules or linked to or reacted with them, biomolecules and/or chemicals used for bioconjugation of biomolecules or surface coating, and a aqueous preferably buffered solution or organic solvent, or their mixture, from where the UCLnNPs are purified and/or separated and/or fractionated and/or analyzed.

The term “flow” shall be understood as fluid dynamics i.e. a movement of buffer, solvent or any liquid optionally comprising sample to and/or through a matrix in a column or on a surface of a bed. The movement of buffer, solvent and other liquids includes laminar, turbulent and transient flow.

The terms “high gradient magnetic separation”. “HGMS”, and “HGMS technique” and corresponding “high gradient magnetic separator”, “HGMS separator” and “HGMS system” shall be understood as a technique/separator/system where a column or a bed packed with suitable matrix or matrixes comprising magnetically susceptible (or ferromagnetic or ferrimagnetic or paramagnetic or superparamagnetic) wires (e.g. steel wool or steel meshes) or particles (e.g. microbeads) is placed inside a strong magnetic field (e.g. provided by a permanent supermagnet or electromagnet/superconducting electromagnet in the vicinity) to enable magnetic gradient within matrix and a force between paramagnetic nanomaterial such as UCLnNPs applied to the matrix. The force results in a capture of the UCLnNPs to the matrix.

The term “capture” shall be understood as a binding or a temporary binding of the UCLnNPs to the matrix resulting in decrease in velocity or a complete stop of the motion of paramagnetic particles such as UCLnNPs in the liquid flow within matrix. The paramagnetic nanomaterials such as UCLnNPs are captured, i.e. bound or temporarily bound to the matrix by the magnetic field gradient as long as the matrix is magnetized (placed inside a strong magnetic field).

The term “vicinity” shall be understood to mean that two objects are close to each others, i.e. there is a short distance between the objects, the distance being typically less than 15 cm. The distance can be also shorter such as 10 cm, 5 cm, 3 cm, or 1 cm or the objects being as close to each other as physically possible.

The term “HGMS column” and “column” shall be understood as a structure housing the matrix.

The term “HGMS bed” and “bed” shall be understood as a structure housing the matrix.

The term “matrix” shall be understood as magnetically susceptible or ferromagnetic or ferrimagnetic or paramagnetic or superparamagnetic wool, mesh or particles or a combination of these. It is used preferably to amplify the magnetic field of the magnets and to create a magnetic gradient.

The term “smallest dimension” shall be understood as shortest dimension of a compact three dimensional object, such as e.g. sphere, cube, or prism, measured as a shortest distance between two outer surfaces connected by a straight line through the centre of the volume of the object. For sphere the smallest dimension is the diameter of the sphere. For cube the shortest diameter is the length of an edge of the cube. For a wire the smallest dimension is the diameter of the wire. For hollow objects, such as toroid, the smallest dimension shall be understood as the diameter of the compact part. For toroid the smallest dimension is the diameter of the compact ring-shaped rod.

The term “center of volume” shall be understood as the point of a three-dimensional object that would coincide with the center of mass of a homogeneous material body having the same boundaries.

### PREFERRED EMBODIMENTS OF THE INVENTION

The presented invention provides a suitable method for separation or purification or analysis or fractionation of lanthanide doped photon upconverting nanomaterials of different sizes or lanthanide compositions from other nanomaterials, biomolecules, proteins, nucleic acids or other molecules such as chemicals used for surface modification or activation during bioconjugation or preparation of labelled reagents for bioanalytical assays, utilizing high gradient magnetic separation (HGMS). It can be applied from large submicron materials to small nanoparticles just nanometers or tens of nanometers in diameter. It is also scalable from small analytical scale to preparative scale.

A typical embodiment of the invention provides a method comprising capture of upconverting lanthanide-doped nanoparticles (UCLnNPs) of a sample comprising said UCLnNPs by a high gradient magnetic separator (HGMS) wherein the weak magnetic, preferably paramagnetic, properties of the lanthanides within the host material in said UCLnNPs enable capture by said HGMS.

In typical embodiments of the invention the sample is an aqueous suspension, suspension in an organic solvent, or a mixture thereof.

In some preferred embodiments of the invention at least 95 mol-%, preferably 99 mol-%, of the lanthanides within the host material of said UCLnNPs are dopants. In some preferred embodiments of the invention the dopant lanthanides are luminescent centres that enable the upconverting property of the UCLnNPs.

In many preferred embodiments of the invention the magnetic properties of the UCLnNPs enabling the capture by HGMS rely mainly, preferably fully, on the paramagnetic properties of the lanthanides, preferably doped, in said nanoparticle. In many preferred embodiments of the invention the magnetic properties of the UCLnNPs rely over 50%, preferably over 90% and most preferably over 99% on the paramagnetic properties of the lanthanides, preferably doped, in said UCLnNPs.

The term “mainly” shall be understood as preferably over 50%, more preferably over 75%, even more preferably over 90% and most preferably over 95%.

I many preferred embodiments of the invention the UCLnNPs do not comprise other magnetic components than the lanthanides doped in said UCLnNPs, which other magnetic components contribute to the magnetic susceptibility of the UCLnNPs to the same extent as, or more than, the paramagnetic properties of the lanthanides doped in said UCLnNPs do. Preferably the other magnetic components than the lanthanides doped in said UCLnNPs, if present, contribute to the magnetic susceptibility of the UCLnNPs less than 50%, preferably less than 10%, more preferably less than 3% and most preferably less than 1% of what the lanthanides doped in said UCLnNPs do.

In some embodiments of the invention the magnetic properties of the UCLnNPs enabling the capture by HGMS rely, preferably mainly, on the paramagnetic properties of lanthanides within, but not doped in, the host material in said UCLnNPs, said host material preferably comprising NaGdF₄.

In preferred embodiments of the invention the method of the invention comprises the steps of

a) providing a column, columns, a bed and/or beds housing one or more ferromagnetic, ferrimagnetic, paramagnetic or superparamagnetic matrix or matrixes,
b) subjecting said column, columns, bed and/or beds to a magnetic field generated with one or multiple magnets placed in the vicinity of said matrix or matrixes,
c) providing a flow of the sample as a suspension comprising UCLnNPs to said column, columns, bed and/or beds while maintaining said magnetic field whereby the UCLnNPs are captured by the magnetic field gradients of said matrix,
d) optionally removing or changing said magnetic field from the vicinity of said matrix, and
e) eluting said UCLnNPs by providing a flow of an eluant to said column, columns, a bed and/or beds.

Preferably the magnetic field is subjected in step b) and optionally removed or changed in step d) by changing the distance or orientation between the magnet or magnets and said column, columns, bed and or beds, and/or, if an electromagnet is employed, by changing or turning on or off the current of said electromagnet.

In typical embodiment of the method of the invention the capture of upconverting lanthanide-doped nanoparticles/UCLnNPs) by a high gradient magnetic separator (HGMS) result in

i) purification of said UCLnNPs, possibly with moieties linked, attached and/or adhered thereto, from other components of the sample comprising UCLnNPs,
ii) separation of said UCLnNPs, possibly with moieties linked, attached and/or adhered thereto, from other components of the sample comprising UCLnNPs,
iii) elution of said UCLnNPs, possibly with moieties linked, attached and/or adhered thereto, to a desired volume of a suspension of said UCLnNPs in a desired, preferably buffered, liquid,
iv) concentration of said UCLnNPs, possibly with moieties linked, attached and/or adhered thereto,
v) fractionation of said UCLnNPs, possibly with moieties linked, attached and/or adhered thereto, by their size, shape and/or composition, and/or
vii) analysis of properties of said UCLnNPs, possibly with moieties linked, attached and/or adhered thereto.

In a preferred embodiment of the invention, when a magnetic field is applied (e.g. placing a supermagnet or multiple of such around the column) to the column packed e.g. with small paramagnetic microbeads and a sample containing e.g. UCLnNPs mixed with biomolecules is applied to column, the experiment results in UCLnNPs staying/concentrating in the column and biomolecules (within elution/washing buffer) eluting from the column. After the magnetic field is removed the UCLnNPs can be simply eluted from the column. This enables very simple and efficient, rapid separation of the UCLnNPs from different biomolecules and chemicals (nonmagnetic materials) without diluting the nanophosphors—or actually concentrating them in a convenient way.

Thus a typical embodiment of this invention consists of a sample to be analyzed, separated or purified, a column or a bed filled with matrix material, a magnetic field, a pump device, a buffer liquid and a detector, wherein
a sample to be analyzed, separated or purified consists of a mixture of the photon upconverting nanoparticles and other material (such as biomolecules and chemicals used for bioconjugation in preparation of labelled reagents for bioanalytical assays).
the column or a bed consists of material (e.g. plastic, glass) housing the matrix,
the matrix material is ferromagnetic or ferrimagnetic or paramagnetic or superparamagnetic wool, mesh, wires or particles or a combination of these,
the magnetic field is a field generated with one or multiple magnets placed in the vicinity of the column,
the buffer liquid is a liquid used to move the sample in the matrix, to wash photon upconverting nanoparticles and eventually elute them from the matrix
the pump device is used to move the buffer liquids containing the particles to be analyzed into the matrix and to wash and elute the particles of the matrix,
the detector is a device able to detect the said photon upconverting nanoparticles equipped e.g. with an infrared laser or another light source and a light detector.

In many preferred embodiments of the invention the host material of the UCLnNPs comprises Y³⁺ or Gd³⁺ or a combination thereof.

In typical embodiments of the invention the UCLnNPs are doped with a lanthanide, preferably a combination of at least two different lanthanides, selected from the group consisting of fifteen chemical elements with atomic numbers 57-71; preferably Yb³⁺, Er³⁺, Tm³⁺, Ho³⁺, Pr³⁺, Gd³⁺, Nd³⁺, Ce³⁺, Eu³⁺ and Tb³⁺; most preferably Yb³⁺, Er³⁺, Tm³⁺ and Ho³⁺; and any combination thereof.

In many preferred embodiments the UCLnNPs are doped with a combination of at least two different lanthanides, preferably Yb³⁺, and one or more of Er³⁺, Tm³⁺ and Ho³⁺. In many preferred embodiments the UCLnNPs comprise NaYF₄ doped with lanthanides.

In typical embodiments of the invention the UCLnNPs do comprise a single host material with preferably homogeneous composition and distribution of lanthanide dopants.

In preferred embodiments of the invention the UCLnNPs comprise at least 50% (w/w), preferably at least 65% (w/w) and most preferably at least 80% (w/w) NaYF₄.

In preferred embodiments of the invention the UCLnNPs comprise

i) at most 50% (w/w), preferably at most 35% (w/w), and
ii) at least 0.1% (w/w), preferably at least 1% (w/w), most preferably at least 5% (w/w)
lanthanides, preferably a combination of at least two different lanthanides, preferably doped in said UCLnNPs.

In many preferred embodiments of the invention the UCLnNPs comprise

i) at most 50% (w/w), preferably at most 35% (w/w), and
ii) at least 0.1% (w/w), preferably at least 1% (w/w), most preferably at least 5% (w/w)
of a combination of Yb³⁺, and one or more of Er³⁺, Tm³⁺ and Ho³⁺, preferably doped in said UCLnNPs.

In some preferred embodiments of the invention the UCLnNPs comprise rare earths of which

i) at most 70 mol-%, preferably at most 35 mol-%, and
ii) at least 0.1 mol-%, preferably at least 1 mol-%, most preferably at least mol-%
are lanthanides, preferably a combination of Yb³⁺; and one or more of Er³⁺, Tm³⁺ and Ho³⁺, preferably doped in said UCLnNPs.

In typical embodiments of the invention the UCLnNPs comprise less than 1% (w/w), more preferably less than 0.1% (w/w), and most preferably not at all, of any of, or any combination of, Fe, Co and Ni.

In typical embodiments of the invention the size range of the UCLnNPs is from 1 nm to 1 μm, preferably from 1 nm to 500 nm, even more preferably from 1 nm to 100 nm, and most preferably from 1 nm to 50 nm.

In some embodiments a column, columns, a bed and/or beds housing one or more ferromagnetic, ferrimagnetic, paramagnetic or superparamagnetic matrix is, or matrixes are, employed for capture of the UCLnNPs.

In some embodiments of this invention the matrix is housed in a bed structure.

In some embodiments of this invention multiple columns and/or beds are used at the same time with one or multiple magnetic fields with different strengths and/or directions.

In some embodiments of this invention glass or plastic is used as a column/bed material.

In some embodiments of this invention the column/bed is a combination of different materials.

In some embodiments of this invention the column/bed consists of fluorinated ethylene propylene tubing.

In some embodiments of this invention the column/bed is bended or otherwise shaped.

In some embodiments of this invention the column/bed is rigid.

In some embodiments of this invention the column/bed is flexible.

In some embodiments of this invention the length of the column/bed is between 5 mm and 50 cm, and in the preferred embodiments between 5 mm and 20 cm.

In some embodiments of this invention the volume of the column/bed and/or the volume occupied by the matrix is between 10 μl and 100 ml, and in the preferred embodiments between 10 μl and 20 ml.

In preferred embodiments of this invention the matrix material is ferromagnetic or ferrimagnetic or paramagnetic or superparamagnetic wool, wires, mesh or particles or a combination of these. In some embodiments the matrix comprises magnetite, hematite, iron, or nickel or their mixture. The shape of the particles or particulate matrix can be of any shape, but spherical shape or almost spherical shape of particles is preferred. Most preferably the matrix material comprises spherical particles.

In preferred embodiments the smallest dimension of matrix material is between 1 micron and 1 mm, and more preferably between 10 microns and 1 mm. The matrix material can be a mixture of different kinds of matrixes with different dimensions, but most preferably the matrix material comprise spherical particles of equal or almost equal size.

In some embodiments of this invention the matrix material is coated with a layer of different material than the matrix itself, e.g. organic polymer, inorganic polymer such as silica, or their mixture. The surface of the matrix material can be also coated by adsorption of detergents or charged polymers such as polyacrylic acids. the surface modification or coating of the matrix can reduce the nonspecific binding of the UCLnNPs on to the matrix improving the yield of the method.

The length of the column/bed and the volume occupied by the matrix can be adjusted to the amount of UCLnNPs to be purified/separated.

In some embodiments of this invention the matrix is held in place with wool kind of structure or a mesh kind of structure or a sponge kind of structure or a combination of one or multiple of these, preferably steel wool, glass wool, or inert plastics such as those comprising fluoropolymers.

In some embodiments of this invention the magnets are one or multiple ring or horse shoe or spherical or rod or cube or toroid or block or disc magnets or a magnet of a flexible nature or any other shaped magnets or a combination of these placed around or in the vicinity of the column/bed in any configuration to provide a magnetic field within the column/bed.

In some embodiments of this invention the magnets are electromagnets or superconducting electromagnets or a combination of these and/or permanent magnets placed in the vicinity of the column/bed.

In some embodiments of this invention the magnetic field is an alternating field.

In typical embodiments of the invention the HGMS employs a magnetic field that is at least 1 mT, preferably more than 0.01 T, more preferably more than 0.1 T and most preferably more than 0.5 T.

In some embodiments of this invention the magnetic field is adjusted by adjusting the flow of electrical current in the electromagnets or superconducting electromagnets. The adjustable or variable magnetic field can be used e.g. to release UCLnNPs of different size or composition at different time to either purify/separate them from each other or quantify/analyze their proportion.

In some embodiments of this invention the magnetic field is adjusted by adjusting the distance of the magnets from the column/bed.

In some embodiments of this invention the magnetic field is removed by physically removing the magnets from the vicinity of the column/bed.

In some embodiments of this invention the magnetic field is removed by removing the electrical current of the electromagnets or superconducting electromagnets.

In some embodiments of this invention the removal of the magnetic field within the matrix is ensured by physically shaking, tapping, knocking or moving the column to cause the matrix to lose the remanent magnetization. Exposure to variable external magnetic field may also result in the same.

In some embodiments of this invention a manually operated syringe is used to move the buffer liquids into the column/bed containing the matrix. In some other embodiments a computer controlled pump is used to provide the liquid flow through the column/bed. The column/bed containing the matrix can be connected to conventional chromatography equipment providing the liquid flow and enable injection of the sample by either autosampler or through manual injector.

In some embodiments of this invention the liquids are moved through the column/bed in a small capillary or capillaries.

In some further embodiments of this invention the liquids are moved by gravity or capillary action.

In some embodiments of this invention the liquids are not in contact with the matrix, but move in a separate cavity arranged inside the matrix.

In some embodiments of this invention the flow rate of the liquids is constant.

In some embodiments of this invention the flow rate of the liquids is variable. The variable flow rate can be used e.g. to adjust the capture of UCLnNPs of different size or composition on to the matrix or release UCLnNPs of different size or composition at different time to either purify/separate them from each others or quantify/analyze their proportion.

In some embodiments of this invention purification is monitored by measuring, either by taking samples or using an on-line detector, the photon upconversion luminescence from the flow through the column or the eluant.

A protocol for separation of UCLnNPs using HGMS according to the invention comprises at least the steps of
a) Equilibrating the column and the matrix with liquid.
b) Introducing a magnetic field to the matrix.
c) Introducing the sample suspension containing the UCLnNPs to be analyzed, purified or separated to the column.
d) Removing the magnetic field.
e) Eluting the UCLnNPs particles bound to the matrix with liquid.

A typical protocol according to the invention comprises the steps of
a) Rinsing the column and the matrix with e.g. ethanol-solution and with a buffer solution.
b) Introducing a magnetic field to the matrix by placing multiple permanent supermagnets in the vicinity or around the column.
c) Introducing the sample containing the UCLnNPs to be analyzed, purified or separated in a buffer solution to the column and thus to the matrix using a pump device.
d) Washing the particles captured in the magnetic gradient produced by the magnets and amplified by the matrix, and possibly collecting the wash liquid.
e) Removing the magnetic field by removing the supermagnets.
f) Eluting the UCLnNPs bound to the matrix in a desired volume of a desired buffer solution, or collecting the elution in fractions.

### DESCRIPTION OF THE DRAWINGS

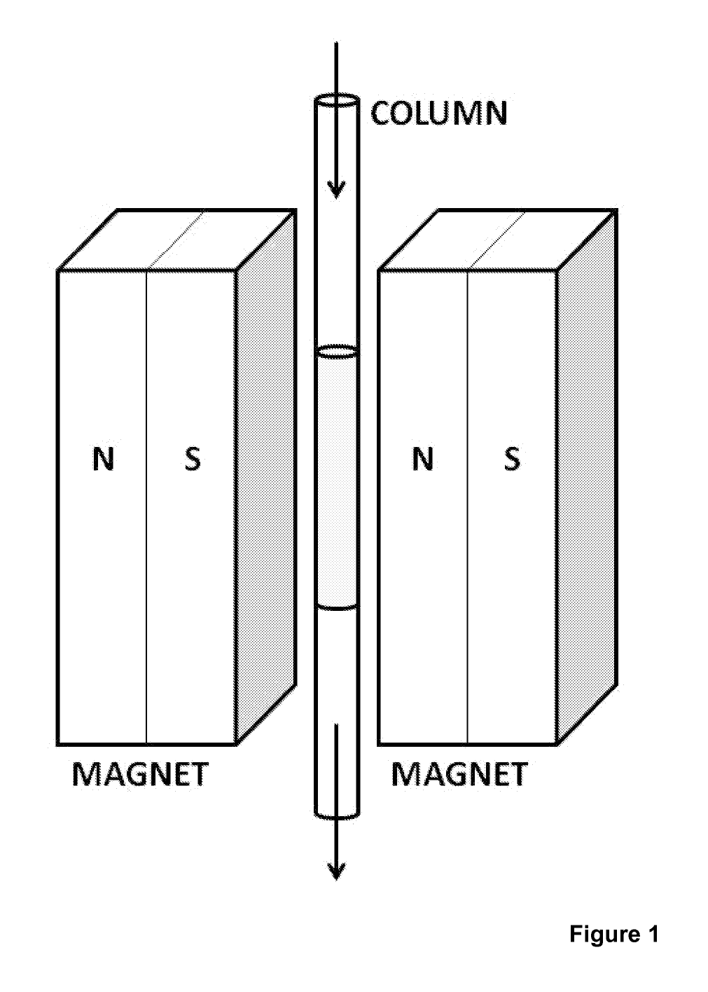

FIG. 1 illustrates a construction of the HGMS-system consisting of a column filled with matrix material and placed in between two identical, permanent, 50×15×15 mm, block-shaped, Cu—Ni-coated, neodymium magnets at opposite sides of the matrix. The N and S indicate the two different poles of the magnets. The arrows indicate the flow direction. The results demonstrate capture of the UCLnNPs on the matrix in the presence of external magnetic field by a method according to the invention.

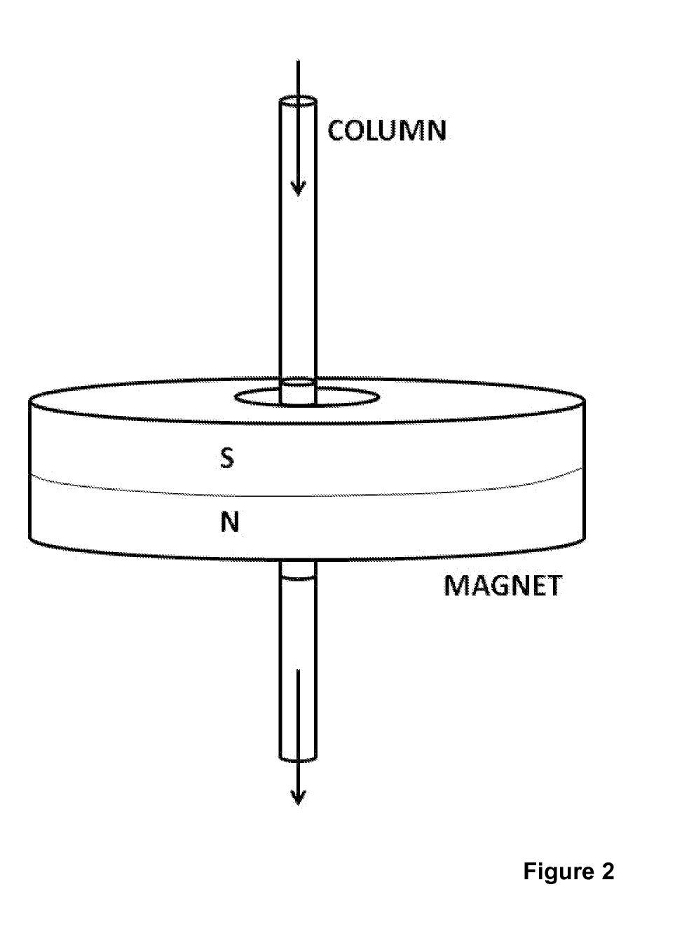

FIG. 2 illustrates a construction of the HGMS-system consisting of a column filled with matrix material and placed in a ring-shaped, permanent, diameter 60 mm, height 30 mm, hole diameter 6 mm, Cu—Ni-coated, neodymium magnet. The N and S indicate the two different poles of the magnet. The arrows indicate the flow direction.

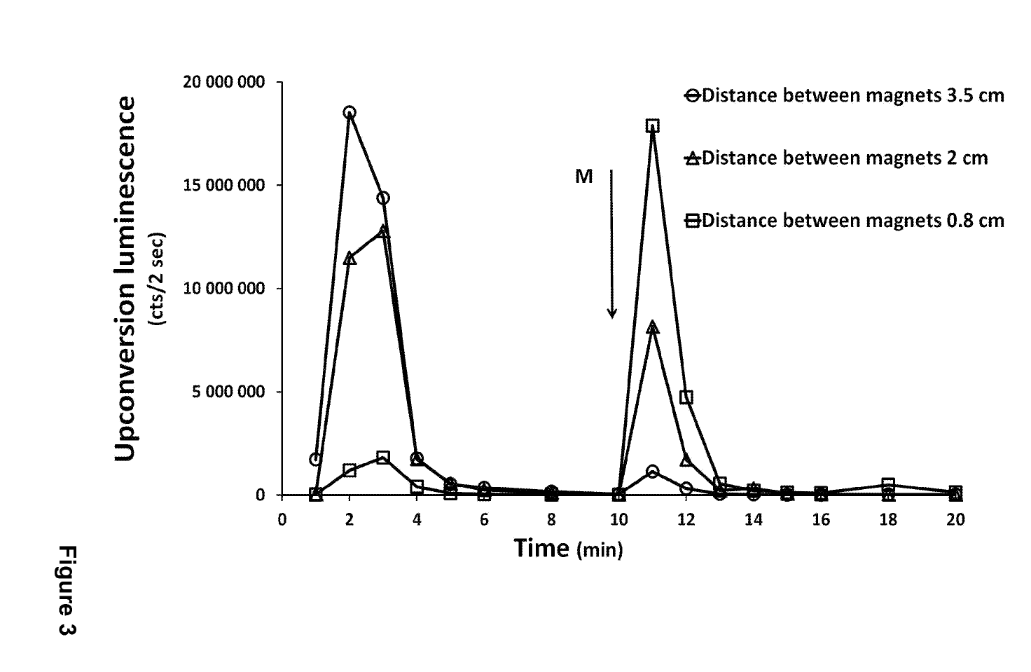

FIG. 3 illustrates the upconverting luminescence of 0-100 nm NaYF₄: 17 mol-% Yb³⁺, 3 mol-% Er³⁺ photon upconverting particles collected in wash and elution fractions at different time points in three different experiments, in which the magnetic field was formed using two identical, permanent, 50×15×15 mm, block-shaped, Cu—Ni-coated, neodymium magnets at opposite sides of the matrix. The same particles were used in all of these experiments, but the distance between the magnets was 3.5, 2 or 0.8 cm which resulted in three different strengths of the formed magnetic field between the magnets. Letter M indicates a point where the magnetic field was removed.

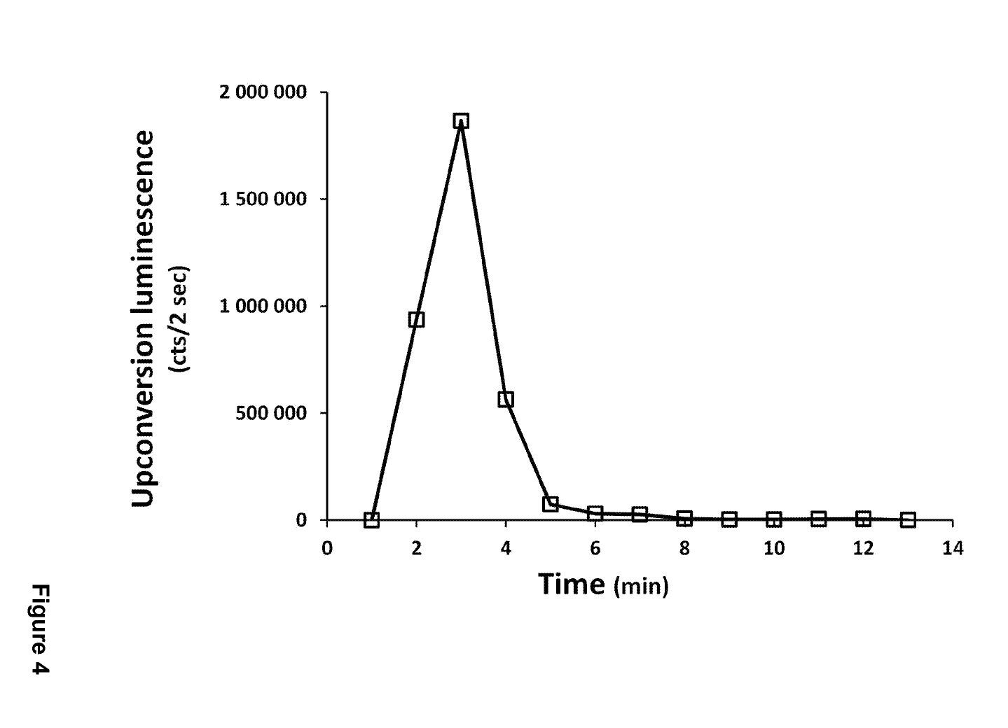

FIG. 4 illustrates the upconverting luminescence of Ø ˜100 nm NaYF₄: Yb³⁺ (17 mol-%), Er³⁺ (3 mol-%) photon upconverting particles collected in elution fractions at different time points in a set-up in which there was no magnetic field present.

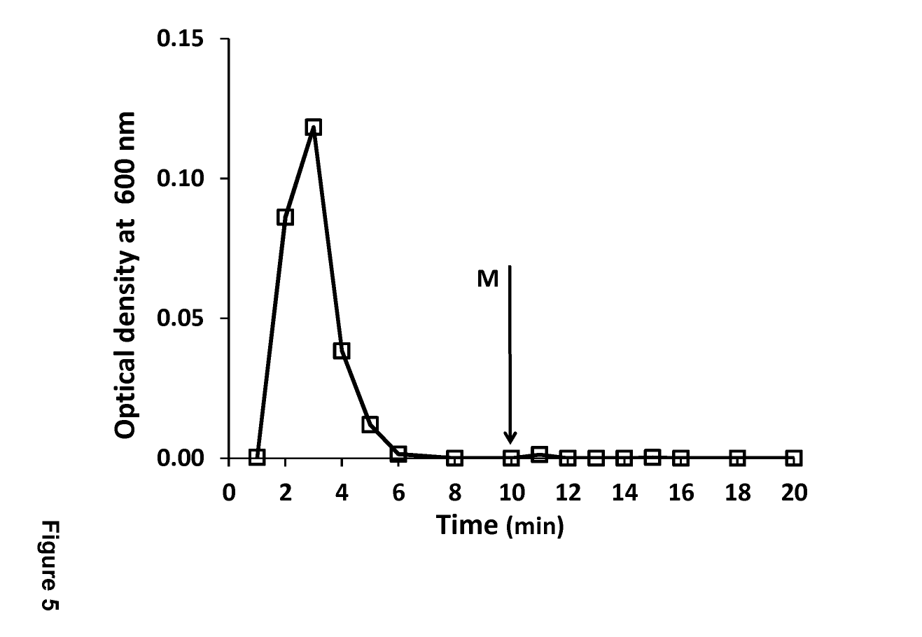

FIG. 5 illustrates the optical density at 600 nm of Estapor micro spheres calibrated blue latex particles, (Ø 0.085 μm, concentration/solid content 10%, Merck Chimie, France) collected in elution fractions at different time points. A set-up with magnets at opposite sides of the matrix was used. The distance between the magnets was 0.8 cm. Letter M indicates a point where the magnetic field was removed.

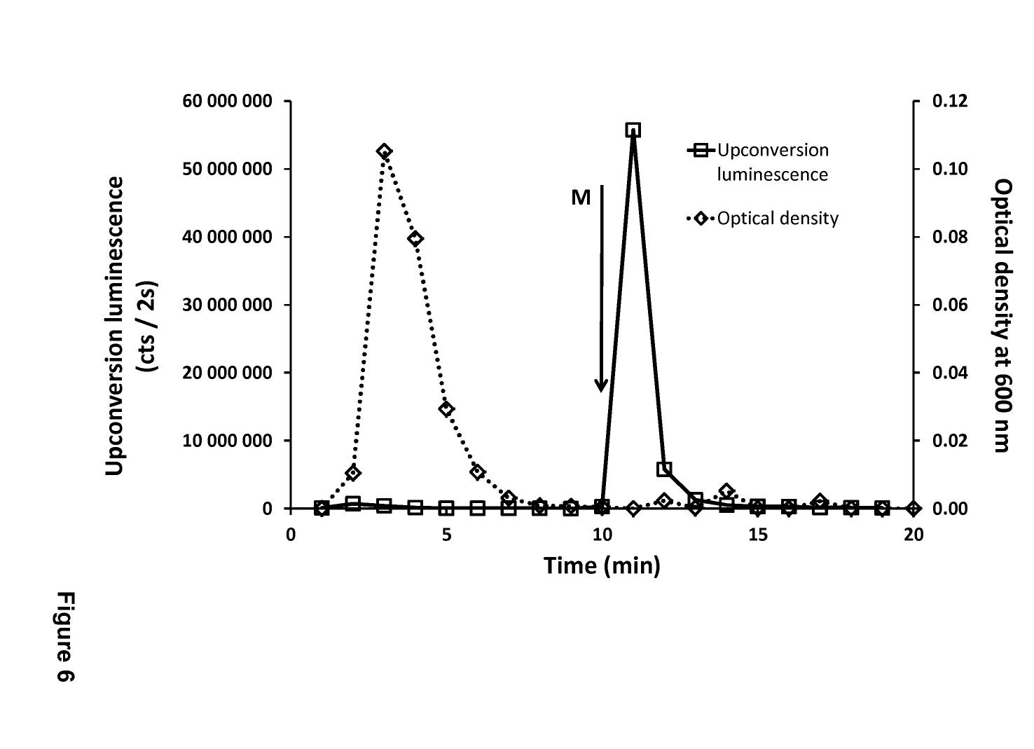

FIG. 6 illustrates the upconverting luminescence and the optical density at 600 nm of a sample comprising a mixture of Ø ˜100 nm NaYF₄: Yb³⁺, (17 mol-%), Er³⁺ (3 mol-%) photon upconverting particles and Estapor microspheres calibrated blue latex particles (Ø 0.085 μm, concentration/solid content 10%, Merck Chimie), respectively, collected in wash and elution fractions at different time points. A set-up with two identical permanent block-shaped, Ni-coated, neodymium magnets (50×20×10 mm) at opposite sides of the matrix was used; i.e. the column containing the matrix was placed in the space between the magnets. The distance between the magnets was 0.5 cm. Letter M indicates a point where the external magnetic field was removed, i.e. magnets were removed from the vicinity of the column. The results demonstrate efficient separation and purification of the UCLnNPs from dyed latex nanoparticles by a method according to the invention,

### EXAMPLES

### Example 1

A column of fluorinated ethylene propylene (FEP)-tubing with an inner diameter of 2 mm (Vici Jour, Switzerland) was used as a column and filled with approximately 500 μl of ferromagnetic spheres (matrix) obtained from MACS LS Column (Miltenyi Biotec, Germany) and washed attached on a series 200 liquid chromatography pump (Perkin Elmer, Finland) with 20% EtOH-solution, 0.5 ml/min for 20 minutes, after which the system was rinsed with measuring buffer A (10 nM borate pH 8.5, 0.1% Tween 20, 0.05% poly(acrylic acid), filtered Ø 0.22 μm), 0.5 ml/min for 15 min. Two identical, permanent, 50×15×15 mm, block-shaped, Ni—Cu—Ni-coated neodymium magnets (Supermagnete, Germany) were attached on a frame 3.5 cm apart from each other and oriented so that the poles with different polarity were facing. This resulted in a static magnetic field with the peak value of 14 mT measured with GM08 Gausmeter (Hirst Magnetic Instruments, UK). The column was placed in between the two magnets. The construction of the HGMS-system is illustrated in FIG. 1.

An amount of 0.063 mg of photon upconverting particles (Ø ˜100 nm NaYF₄: Yb³⁺ (17 mol-%), Er³⁺ (3 mol-%)) in 900 μl of buffer B (same as A but without poly(acrylic acid)) were injected to the system. The column was washed with buffer B 0.5 ml/min for 20 minutes and a total of six 0.5 ml and two 1.0 ml wash fractions were collected, after which the magnets were removed. The column was eluted with buffer B for 20 min and a total of six 0.5 ml and two 1.0 ml elution fractions were collected. The column was also slightly physically tapped after removal of the magnets to reduce the remanent magnetization of the matrix.

The upconversion luminescence of the photon upconverting particles in the collected fractions were measured from 100 μl volume from a clear 96-well Polysorb plate (Nunc, Denmark) with a modified Plate Chameleon multilabel detection platform (Hidex/University of Turku, Finland) with a 500 mW infrared laser diode module (Roithner Lasertechnik, Austria). The device has been previously described by Soukka T, et al. Photochemical characterization of upconverting inorganic lanthanide phosphors as potential labels. J Fluoresc 2005; 15: 513-528. The excitation and emission wavelengths were 980 nm and 550 nm and the emission collection time was two seconds (emission filters 532 nm±25 nm and an IR-blocker, excitation filter 980 nm±10 nm). Results are shown in FIG. 3.

### Example 2

Same as example 1 but the distance between the magnets was reduced to 2 cm. This resulted in a static magnetic field with a peak value of 214 mT. Results are shown in FIG. 3.

### Example 3

Same as example 1 but the distance between the magnets was reduced to 0.8 cm. This resulted in a static magnetic field with a peak value of 572 mT. Results are shown in FIG. 3.

### Example 4

Same as example 1 but without a magnetic field of any kind and the used amount of the photon upconverting particles was 0.45 mg in 900 μl of buffer B. Results are shown in FIG. 4.

### Example 5

Same as example 3 but the particles were 10 μl of Estapor micro spheres calibrated blue latex particles, (Ø 0.085 μm, concentration/solid content 10%, Merck Chimie, France) in 1000 μl of buffer B. The optical density of the fractions with latex particles was measured with Biosense Spectramax Plus 384 Absorbance Microplate Reader (Molecular Devises, USA) at a wavelength of 600 nm. Results are shown in FIG. 5.

### Example 6

The same kind of set-up was used as in example 1 with the following modifications. Stainless steel wool grade 0 (Teräs-Lvi Oy Ab, Finland) was used as matrix. Two identical, permanent, 50×20×10 mm, block-shaped, Ni-coated neodymium magnets (I-Magnet Oy, Finland) were placed 0.5 cm apart from each other and oriented so that the poles with different polarity were facing. The resulted static magnetic field had a peak value of 0.619 T. A sample comprising a mixture of 0,063 mg of photon upconverting particles (Ø ˜100 nm NaYF₄: Yb³⁺ (17 mol-%), Er³⁺ (3 mol-%)) and 10 μl of Estapor microspheres calibrated blue latex particles (Ø 0.085 μm, concentration/solid content 10%, Merck Chimie) in 900 μl of buffer B was injected to the system. A total of ten 0.5 ml wash fractions were collected, and after removing the magnets, ten 0.5 ml elution fractions were collected. Both upconversion luminescence and optical density at 600 nm were detected as in previous examples. Results are shown in FIG. 6.

### Other Preferred Embodiments

It will be appreciated that the methods of the present invention can be incorporated in the form of a variety of embodiments, only a few of which are disclosed herein. It will be apparent for the expert skilled in the field that other embodiments exist and do not depart from the spirit of the invention. Thus, the described embodiments are illustrative and should not be construed as restrictive.

1-22. (canceled)

23. A method comprising capture of upconverting lanthanide-doped nanoparticles (UCLnNPs) of a sample comprising said UCLnNPs by a high gradient magnetic separator (HGMS) wherein the weak magnetic, preferably paramagnetic, properties of the lanthanides within the host material in said UCLnNPs enable capture by said HGMS and at least 95 mol-%, preferably 99 mol-%, of the lanthanides within the host material of said UCLnNPs are dopants.

24. The method according to claim 23, wherein the dopant lanthanides are luminescent centres that enable the upconverting property of the UCLnNPs.

25. The method according to claim 23, wherein the magnetic properties of the UCLnNPs enabling the capture by HGMS rely mainly, preferably fully, on the paramagnetic properties of the lanthanides, preferably doped, in said UCLnNPs.

26. The method according to claim 23, wherein the magnetic properties of the UCLnNPs rely over 50%, preferably over 90% and most preferably over 99% on the paramagnetic properties of the lanthanides, preferably doped, in said UCLnNPs.

27. The method according to claim 23, wherein the other magnetic components than the lanthanides doped in said UCLnNPs, if present, contribute to the magnetic susceptibility of the UCLnNPs less than 50%, preferably less than 10%, more preferably less than 3% and most preferably less than 1% of what the lanthanides doped in said UCLnNPs do.

28. The method according to claim 23, wherein a column, columns, a bed and/or beds housing one or more ferromagnetic, ferrimagnetic, paramagnetic or superparamagnetic matrix is, or matrixes are, employed for capture of the UCLnNPs.

29. The method according to claim 28, wherein the matrix is, or matrixes are, selected from the group consisting of wool, mesh, wires, particles and any combination thereof.

30. The method according to claim 28, wherein the matrix, or matrixes, comprise spherical particles.

31. The method according to claim 28, wherein the smallest dimension of the matrix, or matrixes, is between 1 μm and 1 mm, preferably between 10 μm and 1 mm.

32. The method according to claim 23, wherein the method comprises the steps of
a) providing a column, columns, a bed and/or beds housing one or more ferromagnetic, ferrimagnetic, paramagnetic or superparamagnetic matrix or matrixes,
b) subjecting said column, columns, bed and/or beds to a magnetic field generated with one or multiple magnets placed in the vicinity of said matrix or matrixes,
c) providing a flow of the sample as a suspension comprising UCLnNPs to said column, columns, bed and/or beds while maintaining said magnetic field whereby the UCLnNPs are captured by the magnetic field gradients of said matrix,
d) optionally removing or changing said magnetic field from the vicinity of said matrix, and
e) eluting said UCLnNPs by providing a flow of an eluant to said column, columns, a bed and/or beds.

33. The method according to claim 32, wherein the magnetic field is subjected in step b) and optionally removed or changed in step d) by changing the distance or orientation between the magnet or magnets and said column, columns, bed and or beds, and/or, if an electromagnet is employed, by changing or turning on or off the current of said electromagnet.

34. The method according to claim 23, wherein the capture of upconverting lanthanide-doped nanoparticles (UCLnNPs) by a high gradient magnetic separator (HGMS) results in
i) purification of said UCLnNPs, possibly with moieties linked, attached and/or adhered thereto, from other components of the sample comprising UCLnNPs,
ii) separation of said UCLnNPs, possibly with moieties linked, attached and/or adhered thereto, from other components of the sample comprising UCLnNPs,
iii) elution of said UCLnNPs, possibly with moieties linked, attached and/or adhered thereto, to a desired volume of a suspension of said UCLnNPs in a desired, preferably buffered, liquid,
iv) concentration of said UCLnNPs, possibly with moieties linked, attached and/or adhered thereto,
v) fractionation of said UCLnNPs, possibly with moieties linked, attached and/or adhered thereto, by their size, shape and/or composition, and/or
vii) analysis of properties of said UCLnNPs, possibly with moieties linked, attached and/or adhered thereto.

35. The method according to claim 23, wherein the UCLnNPs are doped with a combination of at least two different lanthanides, preferably Yb³⁺, and one or more of Er³⁺, Tm³⁺ and Ho³⁺.

36. The method according to claim 23, wherein the UCLnNPs comprise NaYF₄ doped with lanthanides.

37. The method according to claim 23, wherein the UCLnNPs comprise
i) at most 50% (w/w), preferably at most 35% (w/w), and
ii) at least 0.1% (w/w), preferably at least 1% (w/w), most preferably at least 5% (w/w)
lanthanides, preferably a combination of at least two different lanthanides, preferably doped in said UCLnNPs.

38. The method according to claim 23, wherein the UCLnNPs comprise
i) at most 50% (w/w), preferably at most 35% (w/w), and
ii) at least 0.1% (w/w), preferably at least 1% (w/w), most preferably at least 5% (w/w)
of a combination of Yb³⁺, and one or more of Er³⁺, Tm³⁺ and Ho³⁺, preferably doped in said UCLnNPs.

39. The method according to claim 23, wherein the UCLnNPs comprise less than 1% (w/w), more preferably less than 0.1% (w/w), and most preferably not at all, of any of, or any combination of, Fe, Co and Ni.

40. The method according to claim 23, wherein the HGMS employs a magnetic field that is at least 1 mT, preferably more than 0.01 T, more preferably more than 0.1 T and most preferably more than 0.5 T.

41. The method according to claim 23, wherein the magnet employed for providing a magnetic field in the HGMS is selected from the group consisting of a permanent supermagnet, an electromagnet and/or a superconducting electromagnet.
